(19) United States
(12) Patent Application Publication
(10) Pub. No.: US 2016/0267426 A1
(43) Pub. Date: Sep. 15, 2016

(54) EARLY RESERVATION OF MANAGED INVENTORY

(71) Applicant: International Business Machines Corporation, Armonk, NY (US)

(72) Inventors: Eugene V. Amigud, Northborough, MA (US); Leho Nigul, Richmond Hill (CA); Amy L. Tennent, Falmouth, ME (US)

(21) Appl. No.: 14/642,800

(22) Filed: Mar. 10, 2015

(51) Int. Cl. G06Q 10/08

(52) U.S. Cl. CPC G06Q 10/087

(57) ABSTRACT

Early inventory reservation is provided. A request for one or more items of a transaction is received, wherein each of the one or more items is a subset of a pool of resources. A first item of the one or more items is classified as an anchor item, based, at least in part, on one or more parameters. In response to classifying the first item as an anchor item, one or more reservation characteristics is assigned to the anchor item. The anchor item is reserved according to the reservation characteristics.

### BACKGROUND OF THE INVENTION

The present invention relates generally to the field of resource management, and more particularly to hierarchical inventory reservation.

Resource management is the efficient and effective deployment of an organization's resources. When a finite number of resources exist, multiple requests for the same resources can cause a conflict between requesting parties. Such finite resources may include financial resources, inventory, production resources, or computing resources.

E-commerce is one common area where resource management is utilized. E-commerce, the trading of goods over the internet, has become a primary way of shopping for many customers. E-commerce allows customers the freedom to shop remotely and provides retailers a method of providing goods with limited overhead. Commonly, digital pictures are used to represent items available for purchase from the e-commerce vendor. Customers can view details about the item and purchase the item through web-based interfaces.

Inventory reservation is the approach used by e-commerce vendors to reserve items selected by customers. The selection of items by the customer is usually indicated by placing the item in an electronic shopping cart. A reserved item is removed from the available inventory of a back end system, making it unavailable for future requests. In some instances, inventory is reserved as soon as the item is requested. In other instances, an inventory is not reserved until the transaction is completed.

### SUMMARY

According to one embodiment of the present disclosure, a method for early inventory reservation of anchor items is provided. The method includes receiving, by one or more processors, a request for one or more items of a transaction, wherein each of the one or more items is a subset of a pool of resources; classifying, by one or more processors, a first item of the one or more items as an anchor item, based, at least in part, on one or more parameters; and in response to classifying a requested item as an anchor item: assigning, by one or more processors, one or more reservation characteristics to the anchor item; and reserving, by one or more processors, the anchor item according to the reservation characteristics.

According to another embodiment of the present disclosure, a computer program product for early inventory reservation of anchor items is provided. The computer program product comprises a computer readable storage medium and program instructions stored on the computer readable storage medium. The program instructions include program instructions to receive a request for one or more items of a transaction, wherein each of the one or more items is a subset of a pool of resources; program instructions to classify a first item of the one or more items as an anchor item, wherein the classification is based, at least in part, on one or more parameters; and in response to classifying the first item as an anchor item: program instructions to assign one or more reservation characteristics to the anchor item; and program instructions to reserve the anchor item according to the reservation characteristics.

According to another embodiment of the present disclosure, a computer system for early inventory reservation of anchor items is provided. The computer system includes one or more computer processors, one or more computer readable storage media, and program instructions stored on the computer readable storage media for execution by at least one of the one or more processors. The program instructions include program instructions to receive a request for one or more items of a transaction, wherein each of the one or more items is a subset of a pool of resources; program instructions to classify a first item of the one or more items as an anchor item, wherein the classification is based, at least in part, on one or more parameters; and in response to classifying the first item as an anchor item: program instructions to assign one or more reservation characteristics to the anchor item; and program instructions to reserve the anchor item according to the reservation characteristics.

### BRIEF DESCRIPTION OF THE DRAWINGS

FIG. 1 is a functional block diagram illustrating a computing environment, in accordance with an embodiment of the present disclosure;

FIG. 2 is a flowchart depicting operations for the early reservation of managed inventory, on a computing device within the computing environment of FIG. 1, in accordance with an embodiment of the present disclosure; and

FIG. 3 is a block diagram of components of a computing device executing operations for anchor item reservation program, in accordance with an embodiment of the present disclosure.

### DETAILED DESCRIPTION

The best approach for allocating resources is a common problem faced in resource management. Approaches used in resource allocation vary based on the objective of the project. For example, efficiency, client satisfaction, and monetary value are some of the competing objectives in resource allocation.

In the example of resource management for e-commerce, two of the conflicting resource allocation approaches are maximizing potential sales and maximizing customer satisfaction. Each of these approaches requires the reservation of inventory at a different time. For example, reserving inventory late in the e-commerce process maximizes potential sales by maximizing the number of potential sales. In contrast, reserving inventory early in the e-commerce process maximizes customer satisfaction.

According to the first approach, which maximizes potential sales, an item is reserved for a customer late in the e-commerce process. For example, the item is reserved in response to receiving a purchase decision from the customer (e.g., customer clicks “check out” in web based interface), or in response to completion of the transaction (e.g., upon receipt of confirmation number). A potential sale for an item is an indication received from a customer that the customer is interested in purchasing an item. An unreserved item in inventory can be the subject of more than one potential sale. Conversely, a reserved item can be subject to only one potential sale. If an item is not available (e.g., if the item is either not in inventory or is reserved for another customer), the potential sale is lost. Therefore, to maximize potential sales, items are not reserved until a customer completes the checkout process for the purchase of the item. The delayed reservation allows other customers to select the item for purchase, increasing the probability that the item is purchased.

Operations to maximize potential sales are needed when customers place items in the electronic shopping cart for an extended time. For example, some customers may use the electronic shopping cart to remind themselves of items they were looking at. In this scenario, the customer may purchase some, all, or none of the items placed in the electronic cart. In another example, customers use the electronic shopping cart to denote items they wish to purchases at a later time. In this scenario, items may sit in the electronic shopping cart for hours, days, or longer before an actual purchase is made.

According to the second approach, which prioritizes customer satisfaction, an item is reserved for a customer early in the e-commerce process. For example, the item is reserved in response to a potential sale of an item (e.g., customer places the item in the electronic cart). Customer satisfaction, in this approach, is inversely proportional to the number of potential sales lost to item availability. Relatedly, the availability of items placed in the electronic shopping cart is a factor in customer satisfaction. To maximize customer satisfaction, an item in inventory is reserved in response to a potential sale of the item to ensure product availability upon customer checkout. Many customers associate the electronic shopping cart to the shopping cart used in physical stores. Like physical shopping carts, customers generally use electronic shopping carts to signify an intent to purchase and reserve items until checkout. Therefore, items that sell out between the time the item is placed in the electronic shopping cart and the time the customer checks out can cause customer frustration.

Prior e-commerce methods, systems, and products require the vendor to choose a time to reserve items (e.g., when placed in the electronic shopping cart, at the purchase decision point, or upon completion of the transaction). This requires the vendor to choose a practice favored toward either potential sales or customer satisfaction.

Embodiments of the present invention provide for balancing multiple inventory management approaches by implementing a hierarchical management system. A hierarchical system ranks the importance of an item to the transaction and reserves the items designated as important (referred to as anchor items) upon receiving a request for the item. Items not designated as important (referred to as auxiliary items) are not reserved until later in the checkout process.

The early reservation of managed inventory can also be used in a computing resources environment where resources are finite. Resources are either mandatory or non-mandatory (i.e., optional). In one embodiment, mandatory resources are required to achieve minimum functionality (e.g., a minimum service-level agreement), while non-mandatory resources are required to achieve optimum functionality (e.g., a target service-level agreement). In the context of a computing environment, this hierarchical management system increases the number of resource requests that can be granted, thereby improving the number of tasks that a computing system can handle concurrently. In one embodiment, mandatory resources are allocated in response to a resource request, while non-mandatory resources are allocated, if available, after a predetermined delay. During this delay, additional resource requests may affect resource availability.

In one example, a cloud computing system hosts multiple software-as-a-service instances. A resource manager of the cloud computing system receives a request to allocate resources for a new instance for a customer. In this example, early inventory reservation can be used to selectively reserve those requested resources that are mandatory for the instance. In this case, the request for resources is denied if the mandatory resources are unavailable, independent of whether the non-mandatory resources are available. If the mandatory resources are available but the non-mandatory resources are not, then the request for resources is granted even though the non-mandatory resources are not allocated to the instance.

In another example, a hypervisor receives a resource request from a new instantiation of a virtual machine for one gigabyte of storage space. The hypervisor determines (based, e.g., on predetermined minimum requirements of the virtual machine) that four hundred megabytes are mandatory and the other six hundred megabytes requested are non-mandatory. The hypervisor grants the resource request (and allocates the resources) if the mandatory resources are available. In the context of a computing environment, the mandatory resources are anchor items while the non-mandatory resources are auxiliary items.

An embodiment of the present invention provides operations to selectively reserve items that are anchor items. For example, an anchor item is reserved in response to a request for the anchor item, while auxiliary items are reserved at a later time. The anchor item reservation allows for a balance between competing resource allocation approaches. The early reservation of anchor items increases the probability that the items of higher importance are reserved first. Further, any items not designated as anchor items are reserved according to the standard reservation policies, allowing them to be allocated differently if there is a greater need elsewhere.

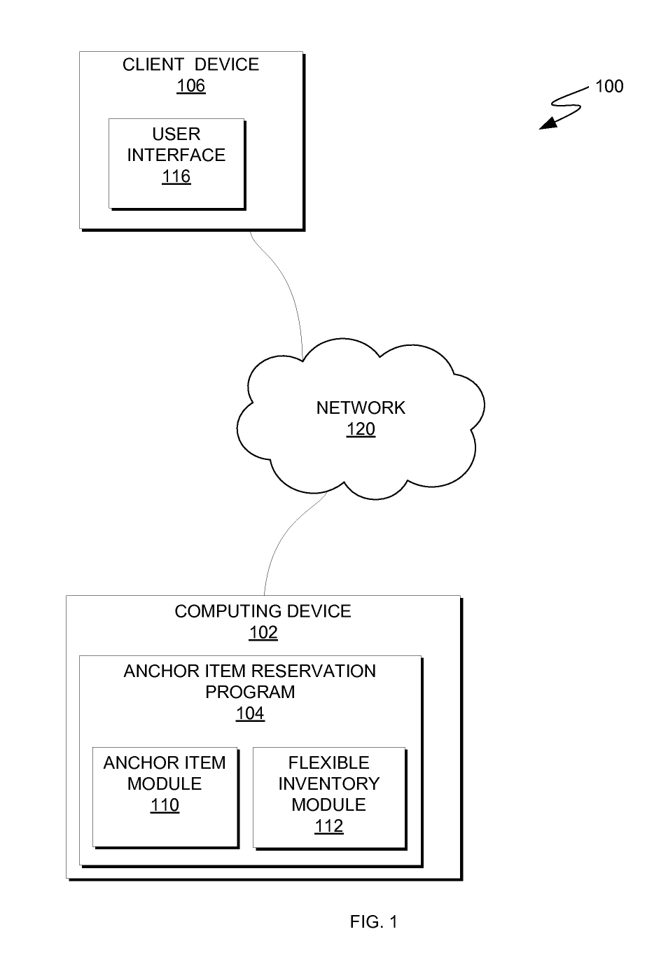

The present disclosure will now be described in detail with reference to the Figures. FIG. 1 is a functional block diagram illustrating a computing environment, in accordance with an embodiment of the present disclosure. For example, FIG. 1 is a functional block diagram illustrating computing environment 100. Computing environment 100 includes computing device 102 and client device 106 connected over network 120. Computing device 102 includes anchor item reservation program 104.

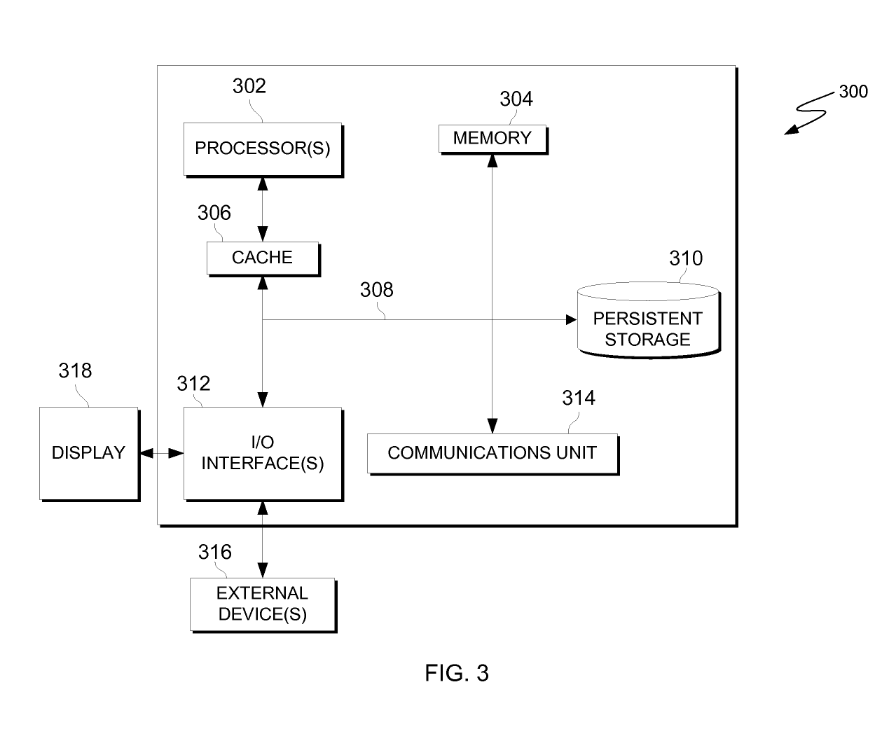

In various embodiments, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to client device 106, and with access to anchor item reservation program 104, and is capable of executing anchor item reservation program 104. Computing device 102 may include internal and external hardware components, as depicted and described in further detail with respect to FIG. 3.

In this embodiment, anchor item reservation program 104 is stored on computing device 102. In other embodiments, anchor item reservation program 104 may reside on another computing device, provided that each can access and is accessible by each other. In yet other embodiments, anchor item reservation program 104 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 102 and client device 106, in accordance with a desired embodiment of the present invention.

Anchor item reservation program 104 is used to determine which items are anchor items. Further, anchor item reservation program 104 determines when to reserve an item based on characteristics associated with each item. Anchor item reservation program 104 balances the competing resource allocation approaches. For example, in an e-commerce setting anchor item reservation program 104 balances the potential sales approach and the customer satisfaction approach. Anchor item reservation program 104 includes anchor item module 110 and flexible inventory module 112. Anchor item reservation program 104 receives item requests, for which it make resource allocation decisions. Item requests come from computing device 102 or another computing device via network 120 (e.g., client device 106).

Anchor item module 110 operates to differentiate an anchor item from an auxiliary item. Anchor item module 110 operates according to parameters established for item classification. Parameters can be static or dynamic. In some embodiments, anchor item module 110 communicates with a database containing information pertaining to available resources.

In embodiments where the parameters are static, specific items are pre-determined to be anchor items. In some embodiments, static parameters are indicated in a resource database. In response to receiving a request for an item in a static anchor item module 110, anchor item reservation program 104 classifies the item as anchor or auxiliary based on its designation in the resource database. In a static anchor item environment, the classification of the item is based only upon the requested item.

In embodiments where the parameters are dynamic, an algorithm is used to determine whether an item is an anchor item under the specific conditions. For example, the algorithm can account for transaction history, marketing data, search criteria, etc. In a dynamic anchor item environment, the classification of the item is based on multiple parameters that are accounted for in the algorithm.

Flexible inventory module 112 operates to determine the timing of reserving items. Inventory can be reserved at multiple points during a resource request transaction. For example, in an e-commerce environment, inventory is reserved upon placing the item in the shopping cart, at the purchase decision, upon entering shipping information, upon entering billing information, upon verification of the order, or upon transaction completion. Flexible inventory module 112 determines when to reserve an item based on the classification of the item as determined by anchor item module 110.

In various embodiments of the present disclosure, client device 106 can be a laptop computer, a tablet computer, a netbook computer, a personal computer (PC), a desktop computer, a personal digital assistant (PDA), a smart phone, or any programmable electronic device capable of communicating with computing device 102 via network 120. Client device 106 includes user interface 116.

Client device 106 includes a user interface (UI), client UI 116, which executes locally on client device 106 and operates to provide a UI to a user of client device 106. Client UI 116 further operates to receive user input from a user via the provided user interface, thereby enabling the user to interact with client device 106. In one embodiment, client UI 116 provides a user interface that enables a user of client device 106 to interact with anchor item reservation program 104 of computing device 102 via network 120. In various examples, the user interacts with anchor item reservation program 104 in order to reserve inventory items. In one embodiment, client UI 116 is stored on client device 106. In other embodiments, client UI 116 is stored on another computing device, provided that client UI 116 can access and is accessible by at least client device 106.

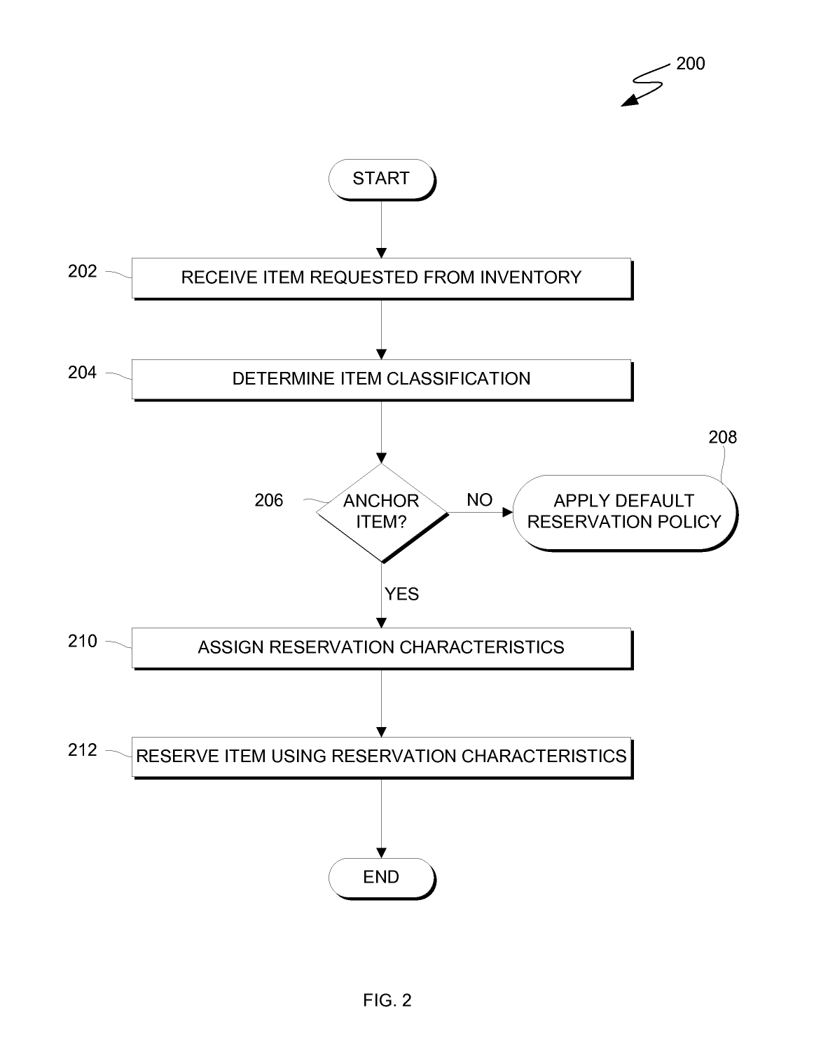

FIG. 2 is a flowchart depicting operations for the early reservation of managed inventory, on a computing device within the computing environment of FIG. 1, in accordance with an embodiment of the present disclosure. For example, FIG. 2 is a flowchart depicting operations 200 of anchor item reservation program 104, on computing device 102 within computing environment 100.

In step 202, anchor item reservation program 104 receives a request for an item in inventory. In an e-commerce embodiment, the request identifies an item added to an electronic shopping cart. In a computing resources embodiment, the request identifies one or more computing resources managed by computing device 102.

In step 204, anchor item reservation program 104 determines the classification of an item. The classification is determined by anchor item module 110 of anchor item reservation program 104. The item is an item identified by the received request. Anchor item module 110 classifies the item as an anchor item or an auxiliary item. The process of classifying an item as anchor or auxiliary can be static or dynamic.

In embodiments where the classification of an item is static, items in inventory are pre-classified as anchor or auxiliary. Further, a static classification is based on the item, and is exclusive of other parameters. In some embodiments, the anchor item module 110 accesses a resource database, containing inventory information to determine the item classification. For example, anchor item module 110 retrieves a classification for an item from a relational resource database that correlates the item to the classification. In other embodiments, the item request includes embedded information concerning the classification of the item for the transaction. For example, the request for an item includes metadata identifying the classification of a requested item.

For example, an e-commerce store is having a sale on hats. The inventory database, containing the store's catalog information, indicates hats are anchor items and all other items are auxiliary items. In response to a hat being added to a user's electronic shopping cart, anchor item reservation program 104 classifies the hat as an anchor item. In response to a shirt being added to the user's electronic shopping cart, anchor item reservation program classifies the shirt as an auxiliary item.

In another example, computing device 102 represents a resource manager in a cloud computing system. In this case, anchor item reservation program 104 receives a request to provision cloud services for a customer. The request identifies a primary service and an add-on service that extends the functionality of the primary service. Based on metadata embedded in the request identifying the add-on service as dependent on the primary service, anchor item reservation program 104 classifies the primary service as an anchor item and the add-on service as an auxiliary item.

In embodiments where the classification of an item is dynamic, the item classification is determined by an algorithm. The algorithm utilizes several parameters established within the anchor item module 110 of anchor item reservation program 104. Parameters used in the dynamic classification include, but are not limited to, marketing data, user history, search criteria, and transaction history.

In an embodiment in the e-commerce environment, the purchase history of the customer is a parameter used to determine the classification of the item. For example, a first customer profile, associated with a first customer, indicates a history of buying electronics, whereas a second customer profile, associated with a second customer, indicates a history of adding items to the electronic shopping cart without completing a purchase. If a stereo is added to the electronic shopping cart associated with each of the customer profiles, the stereo is classified as anchor for the first customer and auxiliary for the second customer.

In an embodiment using market data as a parameter, a user's profile is not necessary. For example, if a new customer without a user profile adds items to the electronic cart, anchor item module 110 determines the item classification based on historical shopping data. For example, a user adds a television and an HDMI cord to the electronic cart. Historical data indicates that users do not complete similar transactions if the television is unavailable; however, users complete the transaction if the television is available and the HDMI cord is not. Therefore, anchor item module 110 classifies the television as an anchor item and the HDMI cord as auxiliary.

In an embodiment in the computing resources environment, the availability of software-as-a-service instances is used to determine the inventory's classification. For example, a request is received for a primary service and a secondary service. Historical data indicates that requests are cancelled if the primary service is unavailable, whereas requests are sustained if the primary service is available and the secondary service is unavailable. Therefore, anchor item module 110 classifies the primary service as anchor and the secondary service as auxiliary.

In decision 206, anchor item reservation program 104 determines whether the item is an anchor item. If anchor item reservation program 104 determines that the item is an anchor item (decision 206, YES branch), then anchor item reservation program 104 assigns reservation characteristics to the anchor item (step 210). If anchor item reservation program 104 determines that the item is not an anchor item (decision 206, NO branch), then anchor item reservation program 104 reserves the item via a default reservation policy (step 208). In one embodiment, anchor item reservation program 104 determines whether the item is an anchor item based on the classification determined in step 204.

In step 208, anchor item reservation program 104 applies a default reservation policy to reserve auxiliary items. In an e-commerce environment, the default reservation period occurs at a specified point in the checkout process. For example, all auxiliary items are reserved in response to completing the transaction (e.g., upon receipt of the confirmation number). In a computing resources environment, the default reservation period occurs during the installation of the program. For example, system memory is allocated to a virtual machine during instantiation of the virtual machine.

In step 210, anchor item reservation program 104 assigns reservation characteristics to each anchor item. Reservation characteristics may include, but are not limited to, when the anchor item is to be reserved, a limit of the length of time of the reservation, or a limit on the number of items to reserve. For example, anchor item reservation program 104 assigns a thirty minute time limit to a reservation of an anchor item. As a result, the anchor item is reserved in response to the request; however, the reservation is cancelled and the anchor item is released after a period of thirty minutes has elapsed if the transaction is not completed.

Reservation characteristics may be static or dynamic. In one embodiment, item reservations are assigned for a static reservation characteristic limiting the time of the reservation to a predetermined duration (e.g., forty-five minutes). In another embodiment, an item reservation is assigned a dynamic reservation characteristic limiting the time of the reservation to a duration that is based on a user profile or customer profile associated with the request. For example, a user has a history of abandoning the electronic cart before completing the transaction. Anchor item reservation program 104 applies a shortened length of reservation (e.g., the item is reserved for thirty minutes instead of the forty-five minutes given to most customer).

In step 212, anchor item reservation program 104 reserves the anchor item using the determined reservation characteristics. Upon reserving the anchor item, the anchor item cannot be allocated to another requestor (unless the reservation expires or the transaction is cancelled). A reservation of an anchor item may be for a specified period, as established by the reservation characteristic, or for an indefinite period.

FIG. 3 is a block diagram of components of a computing device, generally designated 300, in accordance with an embodiment of the present disclosure. In one embodiment, computing device 300 is representative of computing device 102. For example, FIG. 3 is a block diagram of computing device 102 within computing environment 100 executing operations of anchor item reservation program 104.

It should be appreciated that FIG. 3 provides only an illustration of one implementation and does not imply any limitations with regard to the environments in which different embodiments may be implemented. Many modifications to the depicted environment may be made.

Computing device 300 includes communications fabric 308, which provides communications between computer processor(s) 302, memory 304, cache 306, persistent storage 310, communications unit 314, and input/output (I/O) interface(s) 312. Communications fabric 308 can be implemented with any architecture designed for passing data and/or control information between processors (such as microprocessors, communications and network processors, etc.), system memory, peripheral devices, and any other hardware components within a system. For example, communications fabric 308 can be implemented with one or more buses.

Memory 304 and persistent storage 310 are computer-readable storage media. In this embodiment, memory 304 includes random access memory (RAM). In general, memory 304 can include any suitable volatile or non-volatile computer readable storage media. Cache 306 is a fast memory that enhances the performance of processors 302 by holding recently accessed data, and data near recently accessed data, from memory 304.

Program instructions and data used to practice embodiments of the present invention may be stored in persistent storage 310 and in memory 304 for execution by one or more of the respective processors 302 via cache 306. In an embodiment, persistent storage 310 includes a magnetic hard disk drive. Alternatively, or in addition to a magnetic hard disk drive, persistent storage 310 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 310 may also be removable. For example, a removable hard drive may be used for persistent storage 310. Other examples include optical and magnetic disks, thumb drives, and smart cards that are inserted into a drive for transfer onto another computer-readable storage medium that is also part of persistent storage 310.

Communications unit 314, in these examples, provides for communications with other data processing systems or devices, including resources of network 120. In these examples, communications unit 314 includes one or more network interface cards. Communications unit 314 may provide communications through the use of either or both physical and wireless communications links. Program instructions and data used to practice embodiments of the present invention may be downloaded to persistent storage 310 through communications unit 314.

I/O interface(s) 312 allows for input and output of data with other devices that may be connected to computing device 300. For example, I/O interface 312 may provide a connection to external devices 316 such as a keyboard, keypad, a touch screen, and/or some other suitable input device. External devices 316 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 310 via I/O interface(s) 312. I/O interface(s) 312 also connect to a display 318.

Display 318 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1-7. (canceled)

8. A computer program product for early inventory reservation of anchor items, the computer program product comprising:
a computer readable storage medium and program instructions stored on the computer readable storage medium, the program instructions comprising:
program instructions to receive a request for one or more items of a transaction, wherein each of the one or more items is a subset of a pool of resources;
program instructions to classify a first item of the one or more items as an anchor item, wherein the classification is based, at least in part, on one or more parameters; and
in response to classifying the first item as an anchor item:
program instructions to assign one or more reservation characteristics to the anchor item; and
program instructions to reserve the anchor item according to the reservation characteristics.

9. The computer program product of claim 8, wherein the pool of resources comprises one or more finite resources.

10. The computer program product of claim 8, wherein the reservation characteristics include a first reservation characteristic that specifies a time at which to reserve the anchor item and a second reservation characteristic that specifies a duration of reservation.

11. The computer program product of claim 8, wherein the one or more parameters comprise at least one of i) a user profile, ii) one or more marketing results, iii) a search criteria, and iv) a transaction history.

12. The computer program product of claim 8, wherein program instructions to classify the first item of the one or more items as an anchor item is based, at least in part, on data from at least one of i) one or more metadata and ii) a database.

13. The computer program product of claim 8, wherein the pool of resources comprises at least one of i) one or more anchor items and ii) one or more auxiliary items.

14. The computer program product of claim 8, wherein the anchor item is an item that is designated as important based, at least in part, on the one or more parameters.

15. A computer system for early inventory reservation of anchor items, the computer system comprising:
one or more computer processors;
one or more computer readable storage media;
program instructions stored on the computer readable storage media for execution by at least one of the one or more processors, the program instructions comprising:
program instructions to receive a request for one or more items of a transaction, wherein each of the one or more items is a subset of a pool of resources;
program instructions to classify a first item of the one or more items as an anchor item, wherein the classification is based, at least in part, on one or more parameters; and
in response to classifying the first item as an anchor item:
program instructions to assign one or more reservation characteristics to the anchor item; and
program instructions to reserve the anchor item according to the reservation characteristics.

16. The computer system of claim 15, wherein the pool of resources comprises one or more finite resources.

17. The computer system of claim 15, wherein the reservation characteristics include a first reservation characteristic hat specifies a time at which to reserve the anchor item and a second reservation characteristic that specifies a duration of reservation.

18. The computer system of claim 15, wherein the one or more parameters comprise at least one of i) a user profile, ii) one or more marketing results, iii) a search criteria, and iv) a transaction history.

19. The computer system of claim 15, wherein program instructions to classify the first item of the one or more items as an anchor item is based, at least in part, on data from at least one of i) one or more metadata and ii) a database.

20. The computer system of claim 15, wherein the pool of resources comprises at least one of i) one or more anchor items and ii) one or more auxiliary items.
